(19) United States
(12) Patent Application Publication
(10) Pub. No.: US 2008/0033816 A1
(43) Pub. Date: Feb. 7, 2008

(54) METHODS AND SYSTEMS FOR REWARDING SPENDING AND LOYALTY

(76) Inventors: James M. Miller, Sammamish, WA (US); David P. Repp, Seattle, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 11/772,033

(22) Filed: Jun. 29, 2007

Related U.S. Application Data
(60) Provisional application No. 60/817,937, filed on Jun. 30, 2006.

(51) Int. Cl. G06Q 30/00

(52) U.S. Cl. 705/14

(57) ABSTRACT

Systems, methods, and techniques of rewarding spending and loyalty that includes obtaining from a participant a commitment to purchase goods and services from vendors and rewarding participants based on participant purchases are provided. Rewards include a distribution from a rewards fund established, for example, from commissions paid by vendors to the program administrator based in part upon purchases from the vendors by program participants. Rewards are distributed to participants preferably at defined periods or stages, such as a defined period of time of staying married, an age, or a level of purchasing from program vendors. This abstract is provided to comply with rules requiring an abstract, and it is submitted with the intention that it will not be used to interpret or limit the scope or meaning of the claims.

### TECHNICAL FIELD

The described systems, methods, and techniques pertain to providing incentives to program participants for spending loyalty and, more particularly, to rewarding participants, for example couples who stay married.

### BACKGROUND

Loyalty programs are typically business processes for identifying, maintaining, and increasing yield from the best customers. Many such programs offer financial (hard) benefits to provide price incentives to spur consumer loyalty. Such programs can be found in many vertical markets and locations. For example, the loyalty industry currently includes worldwide airline frequent-flyer programs, frequent-shopper program for retailers such as grocery retailers, and programs tied to credit card offerings. Loyalty marketers have adopted the tactics of recognition and reward to identify, maintain, and increase the yield from their best customers. As a result, the loyalty-marketing industry has begun to encounter the telltale characteristics of a mature market. After decades of growth, the loyalty market has shown signs of fatigue from both consumers and practitioners. The proliferation of loyalty programs in the market place has resulted in a market glut as well as the homogenizing of the reward offerings in most programs. Across industries, consumer fatigue appears to be tied to the unimaginative redemption choices found in most reward catalogs.

### BRIEF SUMMARY

The present disclosure is directed to a defined life-stage reward program. In one aspect, the program provides a cash rewards component that helps to offset life-stage expenses such as buying a home, paying for college, or supplementing retirement. The present disclosure includes systems, methods, and techniques for providing incentives to participants, for example newlyweds or engaged couples, to remain married and to stay loyal to each other and to a spending commitment. Couples in the program will utilize services and purchase goods of participating vendors to obtain life-stage rewards, life-style rewards, or to save for retirement, or any combination thereof.

The systems, methods, and techniques of the present disclosure can be adapted to providing incentives to other segments of the population, who are able to make spending commitments and where incentives can be created to encourage such persons to adhere to a time-based commitment to some stage, action, occurrence, or event, etc. in addition to the spending commitment. Such incentive and reward programs may be used to induce behavior modification in a segment of the population.

In accordance with one aspect, a method is provided that includes obtaining a commitment from a participant to purchase goods or services of a vendor, and rewarding the participant based on participant purchases from the vendor. Typically, rewarding is done at defined stages, such as pre-defined or designated times or time periods.

In accordance with another aspect, a method is provided that includes obtaining a commitment to a defined reward, such as a pre-defined reward or pre-defined reward level. The commitment to a defined reward may infer a commitment from a participant to spend a certain quantity per designated time period, purchase a pre-defined amount of goods or services from one or more designated vendors, or other commitments.

In accordance with another aspect, a method includes a defined stage of a period of staying married. In addition, a defined stage can include an age of the participant as well as a defined spending level or a combination of the foregoing.

In accordance with one aspect, a method is provided that includes obtaining a financial spending commitment from a participant, receiving a commission from a vendor based on participant spending to purchase vendor goods or services, generating a rewards fund using at least a portion of the commission, monitoring participant spending, and paying out rewards from the rewards fund to participants at defined stages.

In accordance with another aspect, a system is provided that includes components for storing and retrieving participant and vendor data regarding identification of vendors and participants, financial spending commitments of participants, and participant purchases from vendors; components for generating a rewards fund; and components for paying out rewards to participants at defined stages.

In accordance with another aspect, a system is provided that includes an electronic device that stores and retrieves participant and vendor data regarding identification of vendors and participants, financial spending commitments of participants, and participant purchases from the vendors; an investment vehicle that generates a rewards fund; and distribution mechanism for paying out rewards to participants from the rewards fund at defined stages.

The methods, systems, and techniques of the present disclosure provide a new type of loyalty program which utilizes commitments made ahead of time (a priori commitments) to “defined spending” and “defined reward levels.” For example, a commitment may be in the form of a promise, pledge, or obligation to spend a defined amount (e.g., monetary, quantity of goods/services, etc.) in order to be considered for a pre-defined reward level. By obligating to a particular reward level, a spending commitment per defined time period can be inferred. In some example embodiments, the program is based on a proprietary actuarial business model that delivers engaged and newlywed consumers significant “life-stage” cash payouts. These payouts can be used to supplement retirement or other major life-stage expenses. In one such embodiment, a rewards fund generated by participant purchases are used to provide these life-stage cash payments when various conditions are met.

In one example embodiment, the methods, systems, and techniques of the present disclosure are used to effectuate an experiential rewards program that exclusively targets engaged and newlywed couples and allows them to leverage their everyday spending to accumulate points that convert to major cash rewards at defined intervals. For example, these intervals can be 10, 20, and 30 years. Payouts can range from $5,000 to $1,000,000, or other amount. The example rewards program taps into the retail marketplace by partnering with top retailers, manufacturers, and service providers to drive committed, long-term defined buying behavior of participants in the program in return for material financial rewards.

In one aspect of the example program, spending is tracked automatically via a co-branded credit card or, for example, by registering existing credit cards and/or loyalty cards offered by most merchants. The social value of a program that encourages people to stay married and that provides a significant financial cash reward will be attractive to many consumers.

Participants in the program will be rewarded for being loyal customers to participating vendors and for having successful marriages that stand the test of time. In return, participating vendors have the opportunity to develop long lasting, loyal customers at a point when new families begin, i.e., marriage. Thus, in one aspect, the example program offers the advantages of world-class loyalty-based buying programs and state-of-the-art direct marketing and data mining technologies, while implementing the world's largest guaranteed cash and prize give away exclusively for engaged or newlywed couples. This program also offers its partnering vendors a better return on investment than existing on-line direct advertising solutions and offers its participants an opportunity to save for the future through their regular everyday purchases.

Through the program, vendors are able to share the branding, operational costs, marketing expense, and data ownership of a common loyalty currency, while at the same time building meaningful long-term, one-to-one relationships with newlywed couples as they start their new family together and progress through the various life-stages of buying a home, starting a family, raising children, preparing for college, and on onto retirement. Having engaged and newlywed couples consolidate their purchases by dealing with a select group of companies may appeal to many companies, especially those offering consumer goods and financial services. By delivering targeted participants directly to a vendor's product, the program dramatically lowers the cost of customer acquisition for vendors. In exchange, vendors can build long-term one-on-one direct marketing relationships with participants in the program who keep coming back rather than short-term, price-based, transactional relationships. Vendors optionally have the ability to directly market to participants in the program via a number of dynamic mediums to secure millions of loyal customers for life who keep coming back.

Thus, the example rewards program can focus on establishing real one-on-one relationships with its engaged and newlywed participants based on emotion and trust through offering couples uniqueness and high-perceived value along with significant life-stage financial rewards. Additionally, the program can be used to complement existing proprietary vendor loyalty programs by allowing couples to collect program points more quickly and to achieve much larger and better rewards than previously available with those existing programs.

In some versions of the program, only engaged and newly-married couples that have been married for a defined period of time are eligible to participate and receive rewards. In some versions, membership in the program is free and participants are asked to share detailed personal information about themselves, their buying plans and purchasing habits through monthly interactive vendor-driven on-line surveys that will keep them qualified for the life-stage rewards and other discounts offered by participating vendors. In return, participating couples can receive discounts on everyday purchases of goods and services and can earn points for every dollar (or other monetary increment or currency) they spend with participating vendors. In return they can receive life-stage or life-style reward bonuses at defined reward levels within defined periods. For example, a bonus of $10,000 at 10 years, $100,000 at 20 years, and $1 million or more at 30 years can be offered to selected participants based on the points they have accumulated. Defined periods may be measured from any number of instances in time, including, for example, from initial participation in the program as an eligible participant, or from the beginning of marriage, etc. The points can accumulate over time and are not “redeemed” for rewards. Rather, the higher accumulation of points, presuming other conditions are met, can render the participant eligible for increased rewards. Only those participants that beat defined statistical odds (for example, by staying married), remain loyal to the participating vendors, and continuously achieve their defined spending targets will qualify for these life-stage or life-style reward payouts. In some versions, singles can begin accruing points and receiving some benefits (e.g., vendor discounts); however, they may not be eligible to participate in a program that rewards participants with life-stage or life-style rewards until they become engaged or meet the marriage requirements.

According to one embodiment, the program utilizes a rewards fund that is funded by participating vendors, directly or indirectly. Vendors pay a modest monthly commission back on participant purchases along with one-time integration fees, custom reporting fees, and category exclusivity fees, among other fees, to the program administrator. In return, significant value can be delivered to the vendors by helping the vendors secure meaningful, long-term, one-to-one relationships with participants in the program. The program administrator can use the received commissions and fees to fund the rewards fund, through, for example, an investment vehicle or other mechanism.

In addition, the program administrator can provide the ability to leverage its group of participants to offer insurance, auto buying programs, home buying programs, and other professional products and services at significant savings to the participants. Additional incentives can be offered to participants to drive viral marketing to draw aunts and uncles, parents and grandparents, and friends to buy goods or services from participating vendors by, for example, allowing them to register their credit cards with the participants' accounts to help newlywed couples accelerate their accumulation of points.

The example rewards program can bring together well-known retail and service companies that have augmented their existing loyalty programs with an experiential rewards program. As a result, the example rewards program is able to deliver the established appeal of high-profile brand name retailing partners with a leading edge rewards program to create informative, valuable, and entertaining products for newly-married couples. In the end, the couples that obtain the rewards will have successfully weathered the trials and tribulations of marriage, will have beaten the odds and remained loyal to themselves and to participation in the program and to program vendors for decades. While it is not expected that the systems, methods, and techniques described herein, or programs implemented therefrom, will save all marriages or foot the entire bill for all major life-stage expenses like buying a home, college and retirement, it is expected that these systems, methods, and techniques may contribute substantially to a family's nest egg and to the social well being of a populace.

### BRIEF DESCRIPTION OF THE DRAWINGS

FIG. 1 is an overview flow diagram of an example flow of a participant through an example experiential rewards program.

FIG. 2 is an example block diagram of example components of an example experiential rewards program and interactions between them.

FIG. 3 is an example flow diagram of a process for determining whether a participant is eligible to receive a life-stage reward in an example experiential rewards program.

FIG. 4 is an example block diagram of the components of a system for practicing an experiential rewards program.

FIG. 5 is an example diagram illustrating some of the functions that can be made available to reward programs by one example embodiment of an experiential rewards program system.

FIG. 6 is an example block diagram of a general purpose computer system for practicing embodiments of an Experiential Rewards Program System.

FIG. 7 is an example block diagram that illustrates the activities that can occur between an administrator, participants, and vendors in an experiential reward program configured to implement life-stage rewards for married couples.

FIG. 8 is an example block diagram of a computing system architecture for implementing an experiential rewards program.

### DETAILED DESCRIPTION

The systems, methods, and techniques described herein define a unique approach to hard benefit design, referred to herein as an experiential or aspirational reward. This concept embraces the idea of accumulating points for once-in-a-lifetime experiences, premium merchandise, and life-stage or lifestyle themed rewards that appeal to participants' dreams and aspirations. These enhanced value propositions seek to leverage participants' desires for new, value-added, emotional, experiential, unique, and compelling rewards. An arrangement that handles such rewards is referred to herein as an experiential rewards program or an aspirational rewards program.

An experiential rewards program may offer both hard (financial) and soft benefits as an experiential reward. The following elements/aspects can be used individually and in various combinations as part of the design for an experiential reward in such a program:

A. Soft Benefits: These are benefits that provide special access and/or unique privileges for participants as their membership value increases, e.g., as points accumulate. These recognition elements become a significant differentiator as vendors appeal to more affluent, higher-volume, or higher-spending customers. Because such soft benefit rewards are difficult for competitors to duplicate, they are instrumental in reducing churn in vendors' top-tier customer segments.

B. Personalization: Utilizing data from techniques such as data-driven marketing techniques, the systems, methods, and techniques of an experiential rewards program can personalize rewards and communications for vendors and participants, enabling vendors to “operationalize” their Customer Relations Management (CRM) efforts, offering levels of customer service based on a customer's true lifetime value to the bottom line.

C. Leveraging Vendors: In order to avoid reducing vendors' margins and a program administrator's return on investment due to costs associated with design, implementation, and administration of experiential rewards, vendors can be given the ability to leverage their rewards with other vendors to design and help fund an experiential rewards program. For example, a vendor can offer a reward that is becomes worth more to an eligible participant when combined with rewards from other participating vendors. Utilizing a common exchange currency, vendors can establish strategic partnerships that complement their brands, providing natural outlets for their customers' aspirations, and allowing vendors to grow with customers as the present system obtains a greater scope of implementation.

An example of experiential/aspirational rewards offered through the systems, methods, and techniques described herein include life-stage bonuses at sign-up and then at defined periods, such as ten years, twenty years, and thirty years throughout a defined life-stage, such as a couple's marriage. For example, at sign-up a program participant (such as a married couple) may receive a sign-up bonus and a vendor value pack with pre-loaded discounts from program vendors. In addition, participants can qualify to receive a set dollar amount, towards a vacation or second honeymoon. The defined periods for qualifying for rewards may initiate from the beginning of the defined life-stage, some other point in the defined life-stage, from a point before the life-stage, or from some other point in time. In addition, other eligibility criteria may be used to determine aspects of the experiential rewards.

According to one example experiential rewards program, if a participant couple stays married for ten years, stays alive, has continuously met their defined spending targets, has accrued a predetermined number of points and remained statistically eligible by their ten-year wedding anniversary, they can qualify for a “Life-Stage” cash reward (a specific reward based upon certain life stage events). If a participant couple stays married for twenty years, stays alive, has continuously met their defined spending targets, has accrued a predetermined number of points and remained statistically eligible by their twenty-year wedding anniversary, they can qualify for another Life-Stage cash reward. As noted above, in some programs, the anniversaries are computed relative to when the participant couple began participation in the rewards program (such as at the 33^{rd} wedding anniversary, if a newlywed couple did not join until year three of their marriage). Also, in some forms of the rewards program, the Life-Stage cash rewards are determined ahead of time, for example, by the participant obligating themselves to a reward plan upon program registration. The choice of the reward plan may then dictate a required minimum spending commitment. In some forms, a participant may opt to change their reward plan at a future time, for example, upon allocation of the first Life-Stage reward. Although typically the reward payout levels may be increased, they also may be changed in other manners.

In addition to the foregoing Life-Stage or other defined life-stage rewards, the administrator of the program will give a percentage of its membership base a down payment for a new home. The program may also provide annual anniversary rewards based on participating couples achieving their average annual defined spending commitment with participating vendors. Also, if a participant couple stays married for thirty years, stays alive, has continuously met their defined spending targets, has accrued a predetermined number of points and remained statistically eligible by their thirty-year wedding anniversary they can qualify for yet another Life-Stage cash reward. Other rewards also can be defined by the rewards program.

As mentioned, eligibility for the Life-Stage rewards is in part based upon the participant meeting their spending commitment. As merchandise is purchased or services used points are accumulated. In one example rewards program, these points may be earned sooner than the designated time period (such as starting before the participant is eligible to receive a life stage reward). Also, the points are not converted to rewards—the points continue to accumulate even after rewards are distributed. (Other arrangements, where points are converted also may be supported in other reward programs.) Thus, rewards, such as interim rewards, that may be in part computed based upon accumulated points so far, may vary between participants. Also, in some forms of the program, users may not yet be eligible to register as eligible participants, but they may still be able to “pre-load” their account to accumulate points.

In one incarnation, the program is designed particularly for engaged and newlywed couples. Proof of marriage may be required from all newlywed couples, such as a valid marriage certificate or other verification means defined by the program administrator. These participants will be issued a “device” that verifies their membership, registers existing credit and debit cards, and provides credit. Such a device can be an apparatus or mechanism such as a well-known credit card (e.g., a co-branded credit card), debit card, program ID card, or other appropriate device, which may be issued by the program administrator or its bank card issuing partner or both.

Engaged and newlywed couples fill out an initial membership application, potentially online, identifying the vendors from whom they currently buy goods and services. This information is used by the program administrator to establish a baseline of vendors for each participating couple. In addition, this information can be used to build a “loyalty factor” rating over the course of the program. Qualifying participants then receive a certain number of points for every qualifying dollar they spend with participating vendors in the program.

For vendors, the ability to deepen customer loyalty is important because just getting customers is not enough to sustain growth. With the systems, methods, and techniques described herein, program vendors have the ability to create direct marketing campaigns, offer point-of-purchase materials in the context of the program, conduct educational and other activities, as well as receive ongoing business analytical reports to help vendors assess the over-all and ongoing success of the program. These systems, methods, and techniques provide the program vendors the opportunity to examine each phase of the customer lifecycle for loyalty-building opportunities, including identifying service and product elements that are of value to program participants and establishing exit barriers so that the perceived cost of switching brands dissuades program participants from doing so.

Embodiments of an experiential rewards program allow program vendors to cooperate with each other through a coalition. Two or more primary vendors can share a mechanism by which they agree to “cross-sell” or otherwise share program participants in order for them to earn a common promotional currency. The redemption offers are valued in the same currency through program points that may be redeemed for the program vendors' products, or they may be redeemed for something entirely different. Importantly, program vendors can thereby share their customer bases to achieve a common goal.

A coalition based, experiential rewards program is attractive to program participants, because the relative point earning ability of the participant with respect to other (non-coalition) loyalty programs is that it allows each participant to earn a much greater reward value per year. Management of a coalition based program is independent of any one of the vendors, because the vendors have contracts with the program administrator to issue or redeem the currency of the program. In addition, in one embodiment the vendors preferably only have access to data harvested by the program through a program administrator.

In order to implement an experiential rewards program that can achieve a high degree of success, an administrator of such a program should be first in the market, build new communication channels, achieve rapid market penetration, and deliver attractive and compelling rewards. The ability to do so is driven largely by two factors: (1) that the program participant can collect value from market leading companies across all major sectors, including banking, fuel, supermarket, convenience stores, telecommunications, restaurants, clothes, books, CDs, and others; and (2) that the reward to be offered can be purchased at around 50% of its perceived value, with the benefit being passed on to the program participant (in contrast to competing merchants that run programs that usually buy rewards at about a 10%-20% discount from their perceived value, with the discount often not being passed to the consumer). In an experiential rewards program, these characteristics are achieved in several ways. First, the program employs demographic targeting that uses statistical modeling to define eligibility requirements for the program so that not every participant will hit the defined life-stage periods. Combined with the requirement to hit the defined spending requirements (based upon the commitment level chosen), only a select number of participants will beat the odds and receive the extraordinary life-stage rewards. Thus, demographics such as longevity of marriages, along with computed probabilities that certain events will or will not occur can define reward levels and spending commitment criteria for the program.

A number of factors may be important in establishing a successful experiential rewards program, including obtaining relevant information on the maximum number of customers in a desired target market group; gathering data on demographic, social-economic, lifestyle, and transactional information; developing channels of communications direct to the program participant that are highly cost-effective relative to competitors; and developing barriers to entry that will effectively block competitors from copying an initiative.

Some of an experiential rewards program's strengths over existing programs may include increased interest in the program, fewer cards for program participants to carry, quick point accumulation, greater variety of significant cash rewards, concentrated and coherent promotions, lower costs and time savings in development, professionally-run databases, sector exclusivity, coalition marketing campaigns, high penetration, and real cost benefits. Other advantages are possible.

A coalition thus formed through an experiential rewards program can offer personalization, build emotional ties, and provide significant benefits to its vendors and participants. Such a program can offer program vendors mass customization opportunities to create targeted messages that speak directly to their best customers and address their specific needs. It can also create an emotional tie by making program vendor rewards interactive, timely, and exclusive. Using a combination of hard and soft benefits, such programs can provide financial benefits as well as the soft benefits of recognition and communication with program participants. Thus, experiential rewards programs implemented using the systems, methods, and techniques described provide reduced costs to program vendors and enhanced value propositions. Vendors will end up paying a fraction of the costs that would otherwise be associated with running their own programs, because the vendors will not need to send out direct mails, buy lists, and run ads.

In addition, program participants are likely to increase their loyalty to the program, because they can accrue more value more quickly and receive very large cash life-stage rewards, and only need to have one loyalty card. They do not have to rely on only one provider's products or services to earn points. Thus, using the techniques, methods, and systems of an experiential rewards program, traditional loyalty programs, such as those offered by supermarkets, gas stations, travel operators, financial institutions, telecommunications and internet service providers, hotels, and rental car companies, can all be made available to program participants through a single program and a single card.

Also, a program administrator may utilize a predictive statistical model to establish and qualify continued eligibility of program participants. More specifically, data, such as purchase data coupled with demographic and other statistical data may be used in the predictive model to forecast purchasing probabilities and trends, validate or revise forecasts, and to cooperate with program vendors in marketing of the goods and services. In addition, the data may be used to manage a rewards fund.

In some embodiments, an experiential rewards program is provided that rewards program participants for purchasing a defined amount of products or services from participating vendors and that motivates program participants to meet defined purchase amounts in order to obtain a defined reward. Program vendors may pay commissions to the program administrator in return for participant purchases of products or services from the program vendors.

In one example embodiment (referred to herein as “uTANGO”), a defined experiential rewards program that ideally provides a retirement component is offered exclusively to married couples, and in particular engaged and newlywed couples. The newlyweds commit to a certain level of spending (for example by opting into a particular reward level plan), which is monitored by vendors and the program administrator, and rewards are paid out from a rewards fund to the program participants at defined stages. Such defined stages could be, for example, a period of staying married, reaching a particular age, or spending a predefined amount of money, or any combination of the foregoing. Program vendors pay a commission to the program administrator, for example, based on a defined purchasing level of program participants, and the administrator utilizes these funds in whole or in part to establish a rewards fund from which the life-stage rewards are paid out to eligible participants.

Example embodiments described herein provide applications, tools, data structures and other support to implement an experiential rewards program such as the uTANGO program described above for married couples. In the following description, numerous specific details are set forth, such as program components, data formats and flow or code sequences, etc., in order to provide a thorough understanding of the described methods, systems, and techniques. The embodiments described also can be practiced without some of the specific details described herein, or with other specific details, such as changes with respect to the ordering of the flow, different flows, etc. Thus, the scope of the techniques and/or functions described are not limited by the particular order, selection, or decomposition of steps or acts described with reference to any particular flow or block diagram.

Also, although certain terms are used primarily herein, other terms could be used interchangeably to yield equivalent embodiments and examples. For example, it is well-known that equivalent terms could be substituted for such terms as “rewards,” “incentives,” “CRM,” “loyalty,” etc. In addition, terms may have alternate spellings which may or may not be explicitly mentioned, and all such variations of terms are intended to be included.

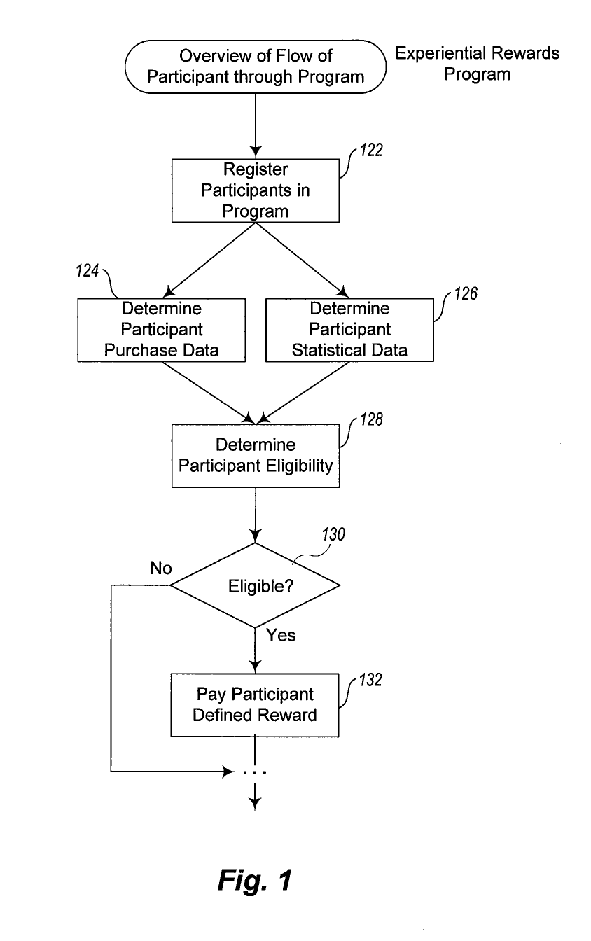

FIG. 1 is an overview flow diagram of an example flow of a participant through an example experiential rewards program. In FIG. 1, program participants are initially registered (step 122) in the program. As part of the registration process, participants provide personal information from which participants' statistical data are derived (step 126). Participating vendors (potentially through transaction processing mechanisms) provide participants' purchase data (step 124). Utilizing the purchase data and statistical data, the participants' eligibility is determined (step 128), including eligibility to participate in the program and eligibility for rewards at various times as defined by the program. If the participant is determined to be eligible (step 130), then, at appropriate times as determined by the program, the participant is then paid a defined reward (step 132) or is given other options as appropriate (such as deferral of the reward). If the participant is not eligible, then the rewards program processes that participant, for example, notifying the participant that the participant is no longer eligible. The rewards program then continues processing for other participants as they move through the various stages of steps 122-132.

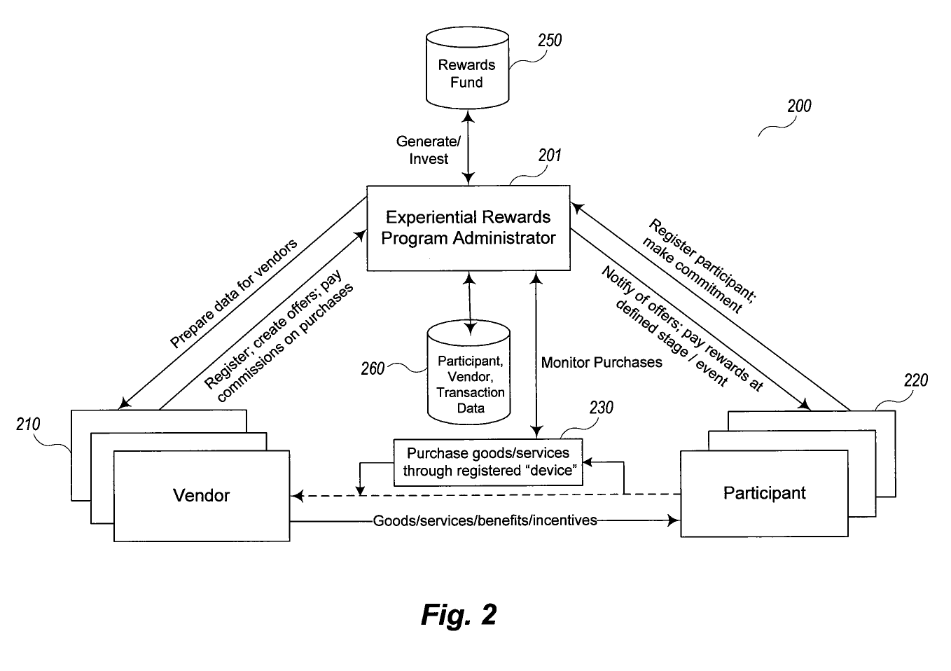

FIG. 2 is an example block diagram of example components of an example experiential rewards program and interactions between them. In FIG. 2, an experiential rewards program administrator 201 (through a system, methods, or techniques) interacts with one or more vendors 210 and one or more participants 220 to achieve an example experiential rewards program 200. The experiential rewards program administrator 201 (“ERPA”) creates, maintains, and manages one or more rewards funds 250 for administering life-stage or life-cycle rewards as described herein. In some embodiments, the rewards fund 250 is part of a system or environment administered by the ERPA 201. The rewards fund 250, may, however, be administered or managed by a third party, such as a financial or investment institution, or a vendor, etc. The ERPA 201 also creates, maintains, and manages participant and vendor data 260, which is used by the ERPA 201 to perform statistical analysis for distribution to the vendors 210. Vendors 210 define offers, which are communicated to the participants 220 through the ERPA 201. Participants 220 purchase goods and services from one or more of the vendors 210, for example, using a registered device 230, such as a co-branded credit card. Purchases made through the registered device 230 can be monitored by the ERPA 201, and the vendors 210. In some embodiments, purchases by participants 220 are made through other mechanisms, and other tracking means (other than through a credit/debit card) are used to monitor purchases. For example, purchases may be made on location at a vendor's physical store and reported separately to the ERPA 201.

In typical operation, the ERPA registers a participant 220 and obtains a commitment, such as a commitment to spend a particular amount buying goods or services from one or more vendors 210 over a defined period of time. These commitments are importantly made prior to becoming eligible for rewards, so that they represent an obligation, pledge, or promise made by the participant. Failure to meet the commitment (for example, after a certain period of time) may result lack of eligibility for the program or for a particular life-stage reward. For example, a participant may make a spending commitment, such as a commitment to purchase some dollar amount of good from the participating vendors, at sign-up. Some times, this commitment can be implied from the participant's selection of a particular reward plan, with pre-designated rewards to be paid out at the various pre-defined life stages. Other combinations are supported.

In one embodiment, the ERPA 201 registers vendors 210 prior to or concurrent with the registration of participants 220. These vendors contract with the ERPA 201 to meet vendor requirements of the administered program. In some embodiments, the vendors 210 pay a commission to the ERPA 201 upon registration, in some cases commensurate with projected data analyzed from the participant, vendor, and transaction data stored in one or more data repositories 260. Such analysis may be performed, for example, using a predictive statistical model.

When a participant 220 initiates a purchase transaction through a registered device 230, the purchase is monitored (directly or indirectly) by the ERPA 201. Accordingly, commissions are received by the administrator 201 from the vendors 210. Commissions can be based wholly or in part on participant purchases. The ERPA 201 generates or invests in a rewards fund 250, using at least a portion of the received commissions. These funds may be used to pay rewards to the participants 220 at defined life-stage or life-cycle events, such as after 10 years of marriage (and after 10 years of program participation, whichever is later) providing the participants 220 meet the other program eligibility criteria, such as meeting spending and/or loyalty commitments. The ERPA 201 calculates participant eligibility typically based upon statistical data as well as purchase data from the monitored purchases as tracked in a data repository 260. A defined reward is then paid by the ERPA 201 to qualified participants 220, preferably at a defined stage. Examples of a defined reward include, but are not limited to, a fixed dollar amount, a privilege, or goods or services of value to the participants, or any combination of the foregoing. The rewards are distributed at defined periods or stages, such as a particular length of marriage, age, etc.

Data from the one or more data repositories 260 may be shared, in whole or in part, with the previously registered vendors 210. For example, purchasing trends of the participants 220 can be transmitted to the vendors 210 electronically or made available to the vendors 210 via secure access, for example over a network such as the Internet.

In some embodiments of an experiential rewards program, the process of rewarding spending and loyalty includes generating and potentially continuing to fund a rewards fund from commissions received from program vendors for sales to program participants, and then paying qualified participants a reward from the rewards fund at defined periods or stages. Eligibility for a reward may be based on a participant meeting the requirements for each reward, including, but not limited to, one or more of: meeting a defined spending level in accordance with a prior commitment, reaching a defined life-stage such as defined wedding anniversaries, and other life-stage periods.

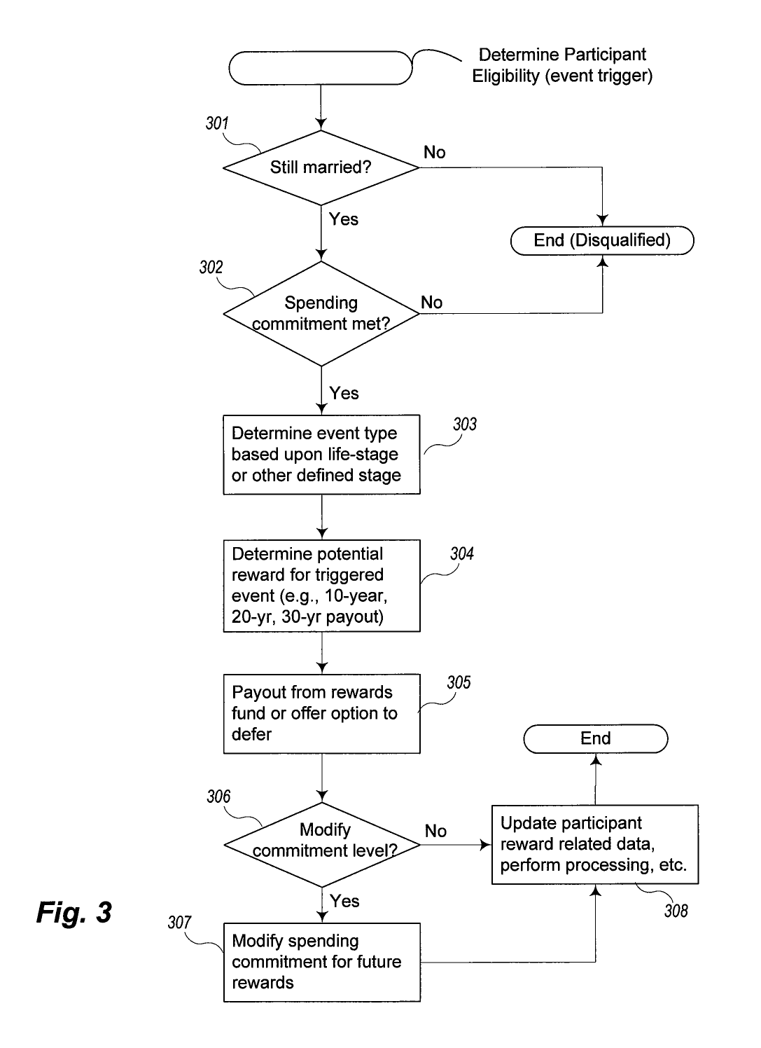

FIG. 3 is an example flow diagram of a process for determining whether a participant is eligible to receive a life-stage reward in an example experiential rewards program. The process of FIG. 3 may be performed, for example, by one or more computing systems executing instructions to support an administrator (such as the ERPA 201 of FIG. 2) to administer program-defined rewards at defined periods or stages. The process first determines whether a designated participant is still eligible to receive the designated life-stage award. For example, in a program designed to reward participants based upon a spending commitment and loyalty to a marriage, in steps 301 and 302, the process determines whether the participant is still married (step 301) and whether the participant has met their spending commitment (step 302). If either of these tests fail, the participant is disqualified. Next, the process determines what kind of reward the participant has qualified for based upon a designated event type (step 303). The reward amounts may be predefined when the program administrator sets up a particular rewards program, and in some cases, may be modifiable based upon other criteria such as amount of vendor participation in the rewards program. The process then determines the particular potential reward for the designated participant, such as based upon the participant's points in the rewards program accrued thus far (step 304). The participant can then opt to receive the determined payout or, in some programs, defer the payout to invest towards the next defined stage payout (step 305). If the program offers an ability for a participant to modify their spending commitment at that point, the process then receives an indication of whether the participant wishes to do so (step 306), and, if so, modifies the commitment for future reward requirements (step 307), otherwise continues. The process then updates the participant's data (step 308) to reflect the reward status, performs other processing as indicated, and ends.

The acts of registering participants (see, e.g., step 122 in FIG. 1) and determining participant eligibility (see, e.g., step 128 in FIG. 1) may be specific to a particular rewards program. For example, with reference to the example experiential rewards program uTANGO (for newly married couples), engaged or newlywed couples are permitted to join the program through a registration process made available by a program administrator. In one embodiment, the registration process is available via a web portal accessible from a web browser or other client application. Upon registration, engaged and newlywed couples select which defined “Life-Stage Rewards Plan” they wish to commit to and, in doing so, establish their defined payout amounts and set their defined spending targets with various program vendors. Participants also establish the date they plan to get married or when they were married. Other data may also be collected by the program administrator as appropriate.

In one form of the uTANGO rewards program, the program requires that engaged and newlywed couples join the uTANGO program prior to the end of three years of marriage (other defined periods can also be supported). Upon registration, a participant couple selects a defined Life-Stage Reward Plan that establishes their annual defined spending commitment to the program. For example, in one embodiment, three plans are offered for $250,000, $500,000, $1,000,000, respectively, which pays out rewards (potentially minimally) at those amounts at a 30-Year Life-Stage Reward when certain annual spending targets are also met and the couple remains married. The spending targets may vary respectively with each plan. In this particular form of the program, participants must average a specific level of spending over defined periods and cannot miss back-to-back years of hitting their spending target, otherwise they risk disqualification. Other programs and forms of the same program can implement different qualification criteria as desired, including different periods for missing spending targets, different defined levels of spending, differing opportunities for changing a spending commitment, etc. At the 10-year mark, participating couples can select several options: (1) they can choose to receive or “defer” their 10-year payout, and, if deferred, the program administrator will add a substantial cash bonus to their 20- or 30-year (or both) Life-Stage Payout, and (2) they can chose to step up to a higher value Life-Stage Rewards Plan for future payouts. If they do chose to step up, they become committed to the spending levels of the new plan and will receive the increase Life-Stage reward payouts, but they cannot drop back down to a lower level plan once they have chosen to step up. Other options are also possible. Note as well that the defined periods or stages, such as the 10-year mark, may be computed differently for different programs, for example, from registration in the program as a newlywed of 3 years instead of at the actual 10-year marriage anniversary mark.

Depending upon the particular program implementation, life-stage rewards can be paid out in multiple methods, such as a pre-loaded debit card or stored-value card equal to the reward value of the specific reward, as an annuity payment over a defined period of time, as an all cash payment, or as a credit towards merchandise with program vendors. According to one form of the uTANGO program, if a participating spouse dies within the first 15 years of the program, the couple is disqualified to receive their 20-year and 30-year Life-Stage payout. If a participating spouse dies after 15 years (e.g., 15 years and one day), the remaining spouse can stay in the program, spend half of what they originally committed to spend as a couple, and receive half the reward payout at 20 years and 30 years. If the couple divorces at any point in the program, they are automatically disqualified. Other combinations and qualification definitions are possible.

In one embodiment of the uTANGO program, singles and engaged persons can join the uTANGO rewards program to begin accruing points for the future (effectuating “endowed progress” towards a future reward). Then, when such persons become eligible, for example, by becoming married, staying married for the predefined amount of time, and meeting their spending commitments, they can receive life stage and life-style rewards such as those described above.

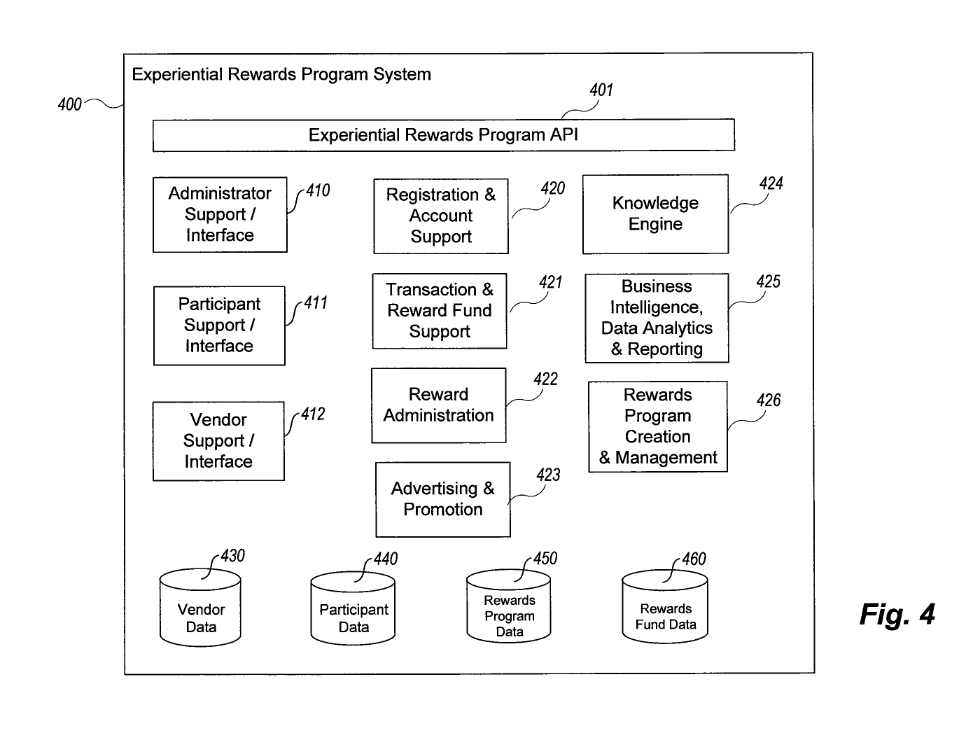

FIG. 4 is an example block diagram of the components of a system for practicing an experiential rewards program. Such a system may be used, for example, by an administer (such as ERPA 201 in FIG. 2) to administer an experiential rewards program such as uTANGO. Of note, the functions indicated as provided by the various blocks may be combined differently, and additional or different blocks may be provided in any particular instance of such a system. Experiential rewards program system 400 (“ERPS”) comprises an administrator support/interface module 410 (such as a web portal, or other user interface) for providing access to the system by administrators, a participant support/interface module 411 for providing access to the system by participants, a vendor support/interface module 412 for providing access to the system by vendors, and, in some embodiments, an application programming interface (an “API”) for providing programmatic access to the functional components, interfaces, and/or data maintained by the ERPS.

The ERPS also includes one or more data repositories 430, 440, 450 and 460 for generating and maintaining vendor, participant, rewards program related, and rewards fund data, respectively. These data repositories may include other demographic, statistical, or analytic data as desired. The data repositories may comprise data stored electronically in one or more data bases, files, tables, or any equivalent data storage structure.

The ERPS also provides various capabilities for manipulating the data stored in repositories 430, 440, 450, and 460 and for handling requests from the various interfaces 401 and 410-412. For example, in FIG. 4, the ERPS is shown as including registration and account support 420, e.g., for managing participant and vendor registrations; transaction and reward fund support 421, e.g., for tracking participant purchases, commission payments, etc.; reward administration 422, e.g., for handling the payout of rewards to participants; advertising and promotion support 423, e.g., for serving ads that promote a coalition of the vendors; a knowledge engine 424, e.g., for advanced handling of customer relations management (“CRM”) activity, including a helpdesk; business intelligence, data analytics and reporting capabilities 425, e.g., for providing statistical analyses of the participant data for one or more of the vendors, including predictive statistical models that may be used by a vendor to define offers; and experiential rewards creation and management capabilities 426, e.g., to allow administrators to create rewards programs with defined levels of participation, defined awards, etc. Other modules and functions can be incorporated similarly.

In some embodiments, the data stored in one of the repositories 430, 440,450, or 460 may be incorporated into one of the other components of the system. For example, the data pertaining to a rewards program may be incorporated into knowledge engine 424.

I n one embodiment, the knowledge engine 424 combines state of the art CRM technology, real-time customer care solutions and a permission-based email platform to deliver a highly dynamic, very reliable, knowledge engine. Such a knowledge engine allows participants to quickly and easily access information for a particular rewards program and thereby reduces customer service challenges for the administrator. Administrators can manage participant growth more efficiently by having the knowledge engine available to provide “intelligent” customer assistance and can analyze and sort information so that the most popular and useful answers will be at the top of the list of knowledge items. Accordingly, participants are able to find answers to questions immediately, minimizing their need to telephone or email the administrator.

The business intelligence, data analytics and reporting capabilities 425 provides data analysis and reports to vendors. In some implementations of an ERP system, the data analytics and reporting capabilities 425 are accessed by vendors using a vendor support interface 412 implemented via a web portal. Analytics may target any type of data stored by an experiential rewards program, including participant data and data specific to a planned or ongoing rewards program. Data analysis may be provided based on customer profile dimensions that allow vendors to drill down into historical data and projected purchase plans to learn more about customer trends and behavior patterns and to apply this learning to future messaging directed to participants and customers. In one embodiment, the analytics are geared towards “power” users looking for reporting and return-on-investment (“ROI”) analysis that goes beyond the standard reporting offered by typical stand-alone CRM systems. The reporting capabilities are provided by reporting tools that allow vendors to slice and dice participant data to view different dimensions, allowing vendors to isolate and analyze specific customer groups based on pre-determined attributes. Data can be organized and viewed according to what makes the most sense for the vendor's business, such as by product, seasons, or customer group.

Analytics for analyzing one or more aspects of a rewards program may be tailored to the vendors' needs by creating a “data-mart” that can be loaded with historical online and offline participant and customer profile data and projected purchase data. Participant and customer profiles can be set up to include broad categories, such as gender and geographic location, or they can be very specific around purchasing patterns and past “click-through” behavior.

Vendors can take advantage of the data relating to a rewards program via new subsets of business data analysis, loyalty analytics, and using advanced, analytical capabilities and new database marketing tools, such as those provided by embodiments of an ERPS to perform mission-critical, twenty-first century, marketing tasks such as: comparing ROI results to forecasts and determining the sensitivity associated with specific variables and recalibrating; measuring customer value in dynamic, ever-changing models; determining the appropriate marketing value proposition and the optimization of the funding rate to yield the greatest historical behavioral change; increasing incremental revenue, one customer at a time, defining specific marketing strategies for increasingly finite customer segments, modeling customer attrition and intervening prior to their departure; modeling cross-sell/up-sell potential, enabling a marketer to put their money where the impact is likely to be greatest; determining the net present value (NPV) of major marketing campaigns and initiatives; customer behavior profiling; customer lifecycle and demographic profiling; customer product preferences and repertoire; customer targeting and differentiation; best customer marketing and win-back; product category relationships and cross-selling; planning and merchandising; online shopping suggestions; and pricing policies.

By analyzing actual purchase behavior along with real-time participant feedback on future buying plans (for example, in the next three, six, and nine months), the business intelligence, data analytics, and reporting capabilities 425 can help vendors determine unique buying patterns of program participants. By adding program specific demographic and lifestyle data of participants, such as when participants intend to get married or when they were married, the program vendors can created specific offers tailored to the various life-stage events of each demographic and leverage their defined spending commitments to drive predictable, long-term, loyal spending behavior. For example, the vendors can create offers for the specific life-stage events of each new family that joins the offered reward program.

The stored data in conjunction with the business intelligence, data analytics, and reporting capabilities 425 can provide a very robust customer profile that provides vendors a complete view of the rewards program participant and delivers very robust analytics for future campaign and offer development. For example, closed-loop one-to-one targeted marketing technology can be used to receive advertising messages, coupons, and discount offers by participants from vendors, send wireless messages, coupons, and discount offers that are personalized, relevant, and anticipated to participants in the program; allow participants to redeem wireless coupons and discount offers at retail stores; capture purchasing events in real time; and update a knowledge database and notify vendors of cross- and up-sale opportunities. In addition, one-to-one e-messaging capabilities are provided to vendors their online customer management process of acquisition, cultivation, conversion, and retention, thus maximizing the customer lifetime value of each of the program participants by delivering participant lifecycle solutions tailored to their specific buying requests and habits. In addition, an experiential rewards program implemented by an ERPS provides an intention-based value network via a permission-based program where participants opt in to receive promotions; participants and consumers provide demographic and psychographic data; and participants and consumers provide personal interest and enthusiast data.

Artificial intelligence modeling can also be provided by the business intelligence, data analytics and reporting capabilities 425 to apply artificial intelligence techniques such as neural networks, decision trees, and statistical techniques to model consumer purchase behavior, to predict participant responses to different incentives, and to help vendors develop incentive programs to achieve marketing goals.

The knowledge that vendors gain from knowing their customers can be used in developing effective campaigns that build their own customer base not only within but also outside of the program and to yield an outstanding return on investment. For example, through relational database technology, a rewards program implemented using an ERPS can provide capabilities to link vendor proprietary data to program in-house prospecting data, giving vendors access to virtually every participant's household. Once the rewards program has cross-referenced the vendors' best prospects profile with the reward program participant data, the program can develop and execute highly successfully customer acquisition campaigns. Services that may be provided by an ERPS in this regard include for example the development, execution and reporting of direct email campaigns, and response tracking and reporting.

An experiential rewards program can provide capabilities to quantify total customer value using its ability to link multiple channels (store, catalog, web, cell-phone). Vendors can be provided with an in-depth, 360-degree view of their customer across all channels, which drives effective marketing and loyalty programs and equips spenders with true decision-making power. The business analytics thus provided include multi-dimensional customer profiling, customer models/profiling-custom built to predict response to other customer behavior, customer recognition and identification system, statistical consulting, advanced segmentation development, customer and business analysis and modeling, and advanced campaign analysis, etc.

Other statistical modeling, business, and data analytics may be provided by and incorporated within a particular embodiment of an ERPS to equip rewards programs as needed, including modeling and analytics not yet conceived.

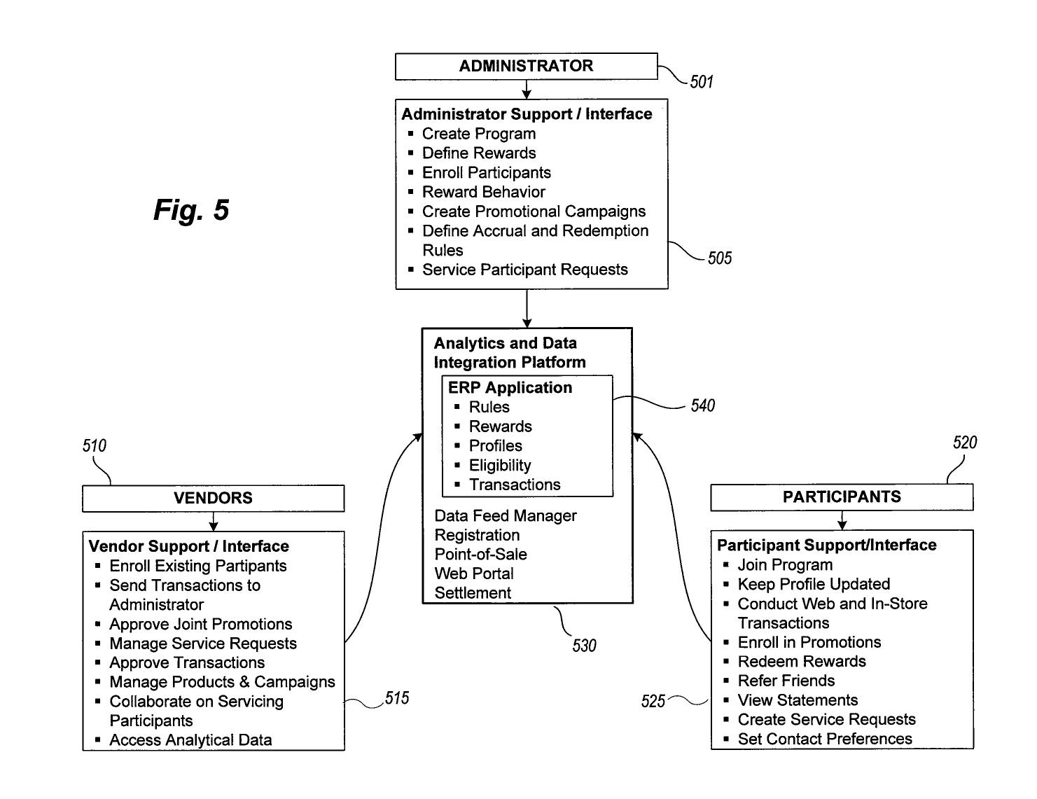

FIG. 5 is an example diagram illustrating some of the functions that can be made available to reward programs by one example embodiment of an experiential rewards program system. The diagram presents many of the same capabilities of the system illustrated in FIG. 4, but from a functional perspective. It demonstrates how a system may be configured to support the activities of an administrator 501, participants 520, and vendors 510.

Specifically, the administrator support/interface 505 provides functions, for example through an administrator “portal,” which allows an administrator 501 to manage a reward program. These functions may include, but are not limited to, creating multiple reward programs, defining tiers within the programs, qualifying and enrolling participants, rewarding behavior, creating targeted promotional campaigns, defining accrual and redemption rules, and servicing participant requests. A portal may be provided, for example, by means of a traditional monolithic graphical user interface, an interface provided by a computing system that also provides the back end support, or a client module, device, web browser, or other application configured to interface to back end ERPS capabilities through a network, such as the Internet. The participant support/interface 525 provides functions, for example through a participant portal, which allows participants 520 to engage in a variety of activities, including, but not limited to, joining a program, keeping a profile up to date, conducting web and in-store transactions, enrolling in promotions, redeeming rewards, referring friends, viewing statements, creating service requests, and setting contact preferences. The vendor support/interface 515 provides functions, for example through a vendor portal, which allows vendors 510 to engage in a variety of activities that include, but are not limited to, enrolling existing participants, sending transactions to a host organization, approving joint promotions, managing service requests, approving transactions, managing products and campaigns, collaborating on servicing participants, and accessing analytical data.

The analytics and data integration platform 530 represents the “back end” capabilities supported by an example ERPS. The ERP Application 540 provides many of the capabilities shown in the blocks of FIG. 4, including, for example, support for defining and managing program rules, rewards, tiers, profiles, and eligibility, and transaction management. The ERP Application 540 may be configured as, for example, a software application, module, or web service having data and instructions to support the functions accessed by the vendors 510, participants 520, and administrator 501, through their respective interfaces 515, 525, and 505. The ERP Application 540 may also be configured as hardware or firmware. The platform 530 also includes the ability to perform enterprise level analytics and data integration to support functions such as registration, point of sale activities, web activities, data feeds, billing, settlement, and other functions.

The infrastructure provided by the analytics and data integration platform 530 allows the administrator to quickly develop data repositories to meet vendor business objectives, access participant data with sophisticated computer-based query tools via the Internet or other standard or proprietary communication lines. Vendors can quickly gain the type of customer insight that fuels their ability to reach customers and drive more frequent and sustained purchasing habits, not only from program participants but from outside customers.

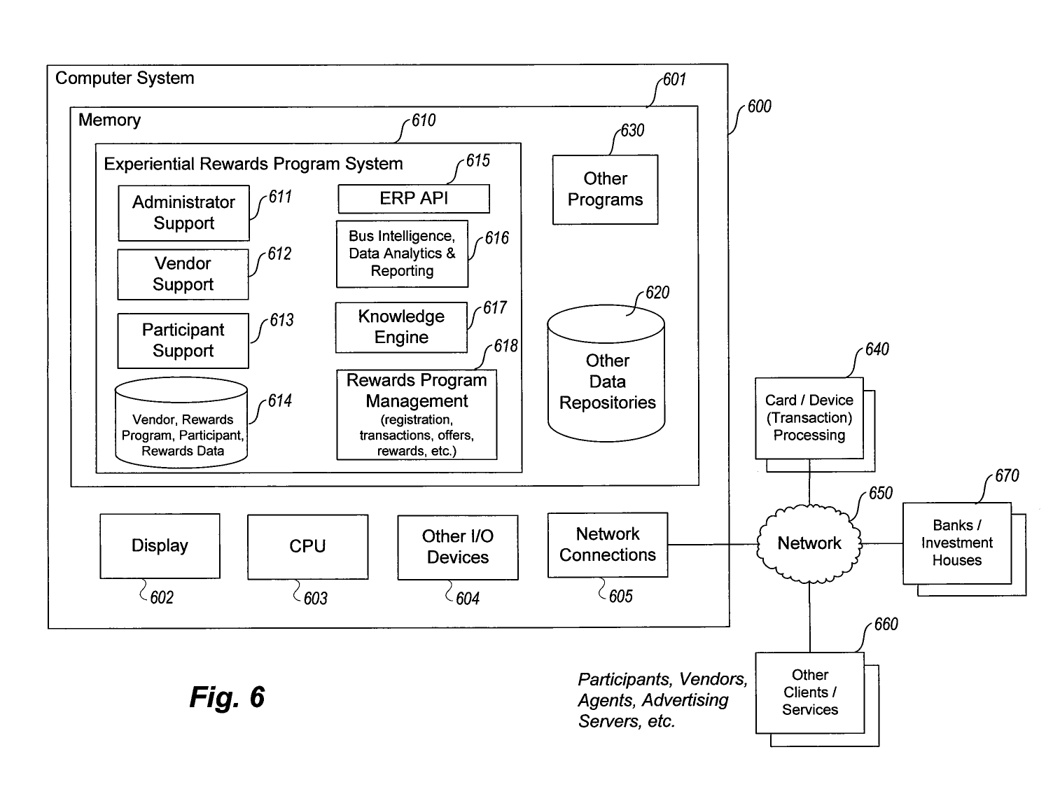

FIG. 6 is an example block diagram of a general purpose computer system for practicing embodiments of an Experiential Rewards Program System. Note that a general purpose or a special purpose computing system may be used to implement one or more of the components of an “ERPS”. The general purpose computer system 600 may comprise one or more server and/or client computing systems and may span distributed locations. In addition, each block shown may represent one or more such blocks as appropriate to a specific embodiment or may be combined with other blocks. Moreover, the various blocks of the Experiential Rewards Program System 610 may physically reside on one or more machines, which use standard (e.g., TCP/IP) or proprietary interprocess communication mechanisms to communicate with each other. Also one or more components may be implemented by software, hardware, firmware, or some combination thereof.

In the embodiment shown, computer system 600 comprises a computer memory (“memory”) 601, one or more displays 602, one or more Central Processing Units (“CPU”) 603, one or more Input/Output devices 604 (e.g., keyboard, mouse, CRT or LCD display, etc.), and one or more network connections 605. The Experiential Rewards Program System (“ERPS”) 610 is shown residing in memory 601. The components of the Experiential Rewards Program System 610 preferably execute on one or more CPUs 603 and manage the generation and use of loyalty and rewards programs, as described in previous figures. Other downloaded code or programs 630 and potentially other data repositories, such as data repository 620, also reside in the memory 610, and preferably execute on one or more CPUs 603. In a typical embodiment, the ERPS 610 includes one or more modules/components 611-618, for example, those as described in FIG. 4. The ERPS may interact with other systems, devices, or services, such as client applications, browsers, or other services 660, transaction processing systems 640, and banks or investments services 670, etc. via a network 650 as described below.

In an example embodiment, components/modules of the ERPS 610 are implemented using standard programming techniques. However, a range of programming languages known in the art may be employed for implementing such example embodiments, including representative implementations of various programming language paradigms, including but not limited to, object-oriented (e.g., Java, C++, C#, Smalltalk), functional (e.g., ML, Lisp, Scheme, etc.), procedural (e.g., C, Pascal, Ada, Modula), scripting (e.g., Perl, Ruby, Python, etc.), etc.

The embodiments described above use well-known or proprietary synchronous or asynchronous client-sever computing techniques. However, the various components may be implemented more monolithic programming techniques as well, for example, an executable running on a single CPU computer system, or alternately arranged using a variety of structuring techniques known in the art, including but not limited to, multiprogramming, multithreading, client-server, or peer-to-peer, running on one or more computer systems each having one or more any of CPUs. Many of the components/techniques are illustrated as executing concurrently and asynchronously and communicating using message passing techniques. Equivalent synchronous embodiments are also supported by an ERPS implementation.

In addition, programming interfaces to the data stored as part of the ERPS (e.g., in the data repositories 614) can be available by standard means such as through C, C++, C#, and Java APIs; libraries for accessing files, databases, or other data repositories; through scripting languages such as XML; or through Web servers, FTP servers, or other types of servers providing access to stored data. The vendor, rewards program, participant, and rewards data 614 may be implemented as one or more database systems, file systems, or any other method known in the art for storing such information, or any combination of the above, including implementation using distributed computing techniques. In addition, the various functions, such as the business intelligence and other data analytics, may be implemented as stored procedures, or methods attached to participant, vendor, function, reward, etc. “objects,” although other techniques are equally effective.

Also the example ERPS 610 may be implemented in a distributed environment that is comprised of multiple, even heterogeneous, computer systems and networks. For example, in one embodiment, the administrator support 611, the knowledge engine 617, and the ERPS data repository 614 are all located in physically different computer systems. In another embodiment, various components of the ERPS 610 are hosted each on a separate server machine and may be remotely located from the tables which are stored in the ERPS data repository 614. Also, one or more of the components may themselves be distributed, pooled or otherwise grouped, such as for load balancing, reliability or security reasons. Different configurations and locations of programs and data are contemplated for use with techniques of described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, etc.). Other variations are possible. Also, other functionality could be provided by each component/module, or existing functionality could be distributed amongst the components/modules in different ways, yet still achieve the functions of an ERPS.

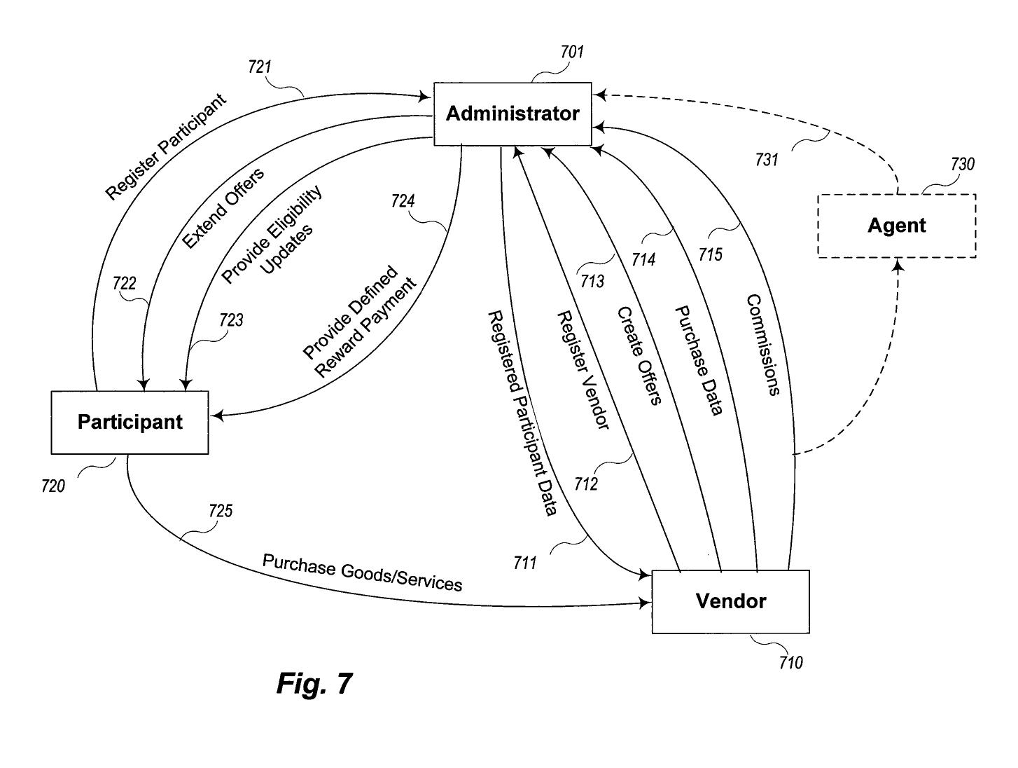

FIG. 7 is an example block diagram that illustrates the activities that can occur between an administrator, participants, and vendors in an experiential reward program, such as one configured to implement life-stage rewards for married couples. The relationships among an administrator 701, participant 720, and vendor 710 in terms of their various activities is illustrated. The various activities (events) 711-715, 721-725, and 731 can occur separately, in parallel, concurrently, or at other defined times and in different orders than those described.

Events 711-715 describe the interactions of vendors 710 with an administrator 701 of an example rewards program. In event 712, the vendor 710 registers itself through the administrator 701 to be part of a rewards program, such as uTANGO. In return, in event 711, the administrator 701 provides the vendor 710 with registered participant information or data. In event 713, the vendors 710 then create offers that are transmitted through (or initiated by) the administrator 701 to the participants 108. These offers may be created using analytical tools and modeling provided by a computing system accessible to the vendor 710 once the vendor has registered. As participants 720 purchase goods and services from vendors (event 725), purchase data is sent in event 714 from the vendors 710 to the administrator 701. Further, in accordance with agreements between the administrator 701 and the vendors 710, in event 715 the vendors 710 pay commissions to the administrator 701 based at least in part on the purchases made by the participants 720. Commissions can also be based upon other data provided to the vendors 710 by the administrator 701, advertising services, and other agreed-upon services provided by the administrator 701. Optionally, an agent person or system 730 can be used as an intermediary between the vendor 710 and the administrator 701 to exchange commissions (event 731) or other information. Such agents 730 can include, but are not limited to, banks, transfer agents, and other settlement means of financial institutions.

Events 721-724 describe the interactions of participants 720 with an administrator 701 of an example rewards program. In event 721, participants 720 interact with an administrator 701 or the particular rewards program, such as uTANGO, to register a participant 720 in the program. In events 722 and 723, the administrator 701 provides offers to the participants 720, along with eligibility updates. The offers are typically based upon the offers created by vendors 710 in event 713. When a participant 720 becomes eligible for a reward, then in event 724 a defined reward payment is provided to the eligible participant 720 from or under the direction of the administrator 701.

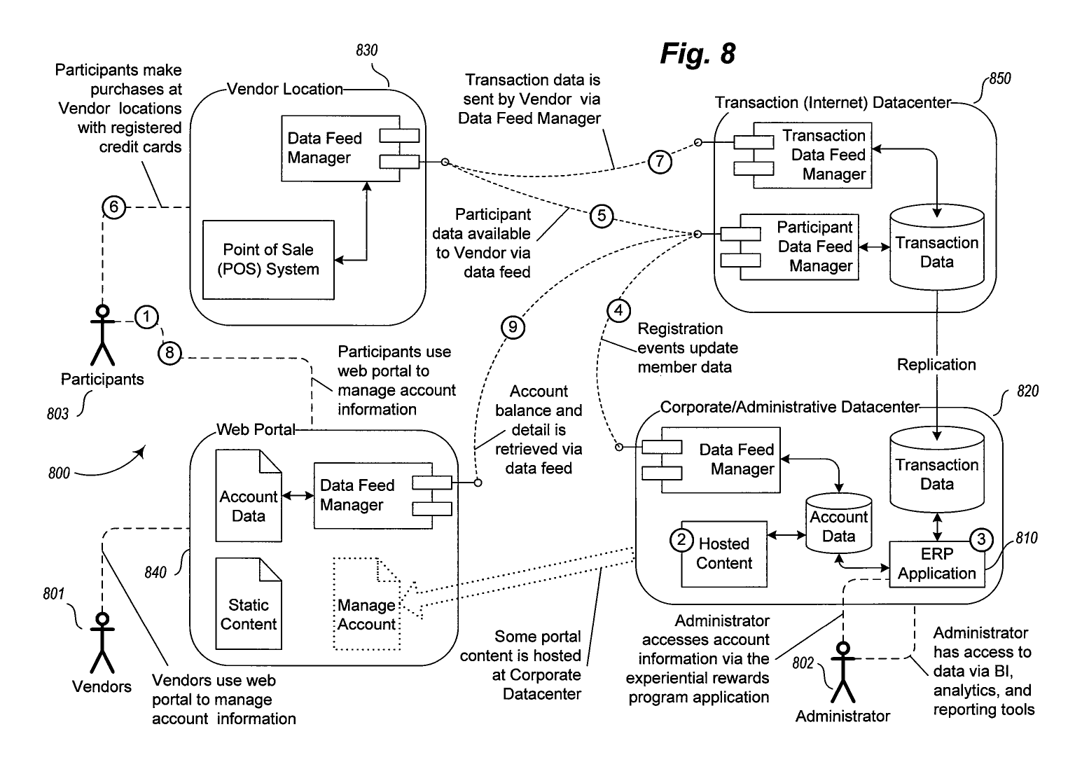

FIG. 8 is an example block diagram of a computing system architecture for implementing an experiential rewards program. The illustrated architecture 800 can be used to implement the methods, systems, and techniques described in the previous figures, and can be configured to implement a life-stage rewards program for married couples, such as that provided by uTANGO. In one embodiment, the architecture 800 is utilized by one or more administrators 802, one or more participants 803, and one or more vendors 801, preferably via a communications network such as the Internet.

According to one embodiment of the architecture 800, a network connects at least one web portal 804, one or more vendor locations 830, an Internet datacenter 850 (or equivalent transaction tracking system over the network), and an administration/corporate datacenter 820 (or equivalent), which supports the data accessible to one or more administrators 802. A participant 803 and a vendor 801 can use the web portal 840 to access and to manage account information, such as the participant's account relating to a particular vendor. Some of the account information may be hosted separately in the system accessible to the administrator 802, for example the datacenter 820. Other information, such as the balance available in the account or associated with a loyalty, debit, or credit card, may be updated by the transaction datacenter 850, as transactions are processed. A third party service/application may be used to host the data and to provide the management of the accounts by serving web pages to the web portal 840 as needed to manage the accounts and/or card registration.

The administrator 802 interfaces to the administration/corporate datacenter 820 through an experiential rewards program (ERP) application 810. The ERP application 810 allows the administrator 802 to access vendor and participant account related information, transaction data, and supports the business intelligence, data analytics, and reporting tools.

The transaction data resident in the administration/corporate datacenter 820 is kept up to date by the transaction (Internet) datacenter 850. For example, it may be an automatically replicated database, which is updated whenever transactions occur or at other times. The account data in the administration/corporate datacenter 820 is also kept up to date by the transaction (Internet) datacenter 850. Account registration changes initiated at the web portal 840 are fed to the transaction datacenter 850, which are then reported to and/or replicated in the administration/corporate datacenter 820, potentially automatically.

In some configurations of the example architecture 800, the administration/corporate datacenter 820 may be comprised of multiple systems and third party applications, which individually provide some aspect of the capabilities of the ERP application. For example, a third party system may be used to provide and served hosted pages and data for the web portal. Another third party system may be used to provide a data analytics engine that integrates with the account and vendor data to provide business intelligence and data analytics to the administrator 802.

When a transaction occurs, such as at a point of sale system of a vendor location 830, transaction data is sent (potentially automatically) to the transaction (Internet) datacenter 850. This data is then stored and replicated as appropriate throughout the rest of the architecture 800. A vendor location 830 may be a physical location such as a store or a vendor website. As needed, a system (such as a point of sale system) at the vendor location 830 may request participant related data from the transaction datacenter 850.

As shown, it is contemplated that at least a portion of the data can be transferred and shared automatically by the various systems 830, 840, 850, and 820 using various single and bi-directionally communications as appropriate. The “data feed manager” present in these system refers to any means for sending and receiving data as appropriate to the encompassing system, including but not limited to API, web service, and database transaction processing.

All of the above U.S. patents, U.S. patent application publications, U.S. patent applications, foreign patents, foreign patent applications and non-patent publications referred to in this specification and/or listed in the Application Data Sheet, including but not limited to U.S. Provisional Patent Application No. 60/817,937, entitled “SYSTEM AND METHOD OF REWARDING SPENDING AND LOYALTY,” filed Jun. 30, 2006, are incorporated herein by reference, in their entirety.

From the foregoing it will be appreciated that, although specific embodiments have been described herein for purposes of illustration, various modifications may be made without deviating from the spirit and scope of the present disclosure. For example, the methods, systems, and techniques for providing experiential rewards discussed herein are applicable to other architectures other than a client-server, or web based architecture. Also, the methods and systems discussed herein are applicable to differing protocols, communication media (optical, wireless, cable, etc.) and devices (such as wireless handsets, electronic organizers, personal digital assistants, portable email machines, game machines, pagers, navigation devices such as GPS receivers, etc.).

1. A system for administering consumer loyalty based rewards, comprising:
at least one electronic device that is configured to store and retrieve participant and vendor data regarding identification of vendors and participants, defined financial spending commitments of participants, and participant purchases from the vendors;
a vehicle that is configured to generate a rewards fund; and
a distribution mechanism that is configured to distribute rewards from the rewards fund to participants at defined stages.

2. The system of claim 1 wherein the distribution mechanism configured to distribute rewards from the rewards fund to participants at defined stages is further configured to allow deferral of a reward from the rewards fund to be paid out to participants at future defined stages.

3. The system of claim 1 wherein the distribution mechanism pays out rewards from the rewards fund to participants in part based upon spending volume.

4. The system of claim 1 wherein the distribution mechanism is an investment fund.

5. The system of claim 1 wherein the vehicle that is configured to generate the rewards fund is further configured to receive commissions from vendors based on participant purchases and to use at least a portion of the commissions to generate the rewards fund.

6. The system of claim 1 wherein the vehicle that is configured to generate a rewards fund is a computing system that receives money from vendors or third party entities on behalf of the vendors.

7. The system of claim 1 wherein the defined stages are pre-defined such that participants can obligate themselves to a rewards plan with designated rewards prior to becoming eligible for the rewards.

8. The system of claim 7 wherein the participants can obligate themselves to the rewards plans concurrent with registering in a rewards program.

9. The system of claim 7 wherein the participants can obligate themselves to the rewards plans prior to purchasing goods or servers from the vendors.

10. The system of claim 1 wherein at least one of the defined stages comprises a period of staying married or staying alive.

11. The system of claim 1 wherein the defined stages are anniversaries of marriage.

12. The system of claim 1 wherein at least one of the defined stages are a ten year anniversary, a twenty year anniversary, or a thirty year anniversary of a marriage.

13. The system of claim 1 wherein at least one of the defined stages is based upon an age of a participant.

14. The system of claim 1, wherein the electronic device is further configured to screen participants to only accept engaged, newly-wed, or single persons as participants.

15. The system of claim 14 wherein newly-wed persons are persons married less than three years.

16. The system of claim 1 wherein the defined stages are based upon a demographic with limited odds of success.

17. The system of claim 16 wherein the demographic relates to marriage.

18. The system of claim 1 wherein the defined financial spending commitments of participants designate an minimum amount of goods or services to be purchased from the vendors.

19. A method for providing a rewards program, comprising:
obtaining from a participant an indication of a commitment to purchase a designated amount of goods and services from at least one vendor;
monitoring participant purchases; and
at a predetermined stage of life of the participant, distributing to the participant at least a portion of a rewards fund based on the monitored participant purchases.

20. The method of claim 19, further comprising:
obtaining from the participant an indication of a commitment to a reward level to be distributed at the predetermined stage of life of the participant.

21. The method of claim 20 wherein the obtaining from the participant the indication of the commitment to the reward level provides the obtaining from the participant the indication of the commitment to purchase the designated amount of goods and services from the at least one vendor.

22. The method of claim 20 wherein the obtaining from the participant the indication of the commitment to the reward level is obtained when the participant registers in the program.

23. The method of claim 19 wherein the obtaining from the participant the indication of the commitment to purchase the designated amount of goods and services from the at least one vendor is obtained when the participant registers in the program.

24. The method of claim 19, further comprising:
receiving commissions from one or more vendors; and
generating the rewards fund from the received commissions.

25. The method of claim 24 wherein the receiving the commissions is based at least in part on purchases made by the participant.

26. The method of claim 19, wherein the distributing to the participant the at least the portion of the rewards fund is performed if the participant has met the indicated commitment to purchase the designated amount of goods and services.

27. The method of claim 19 wherein the predetermined stage of life of the participant is based upon the participant reaching a prior established milestone in married life.

28. The method of claim 27 wherein the prior established milestone in married life relates to at least one of a ten year, twenty year, or thirty year anniversary.

29. The method of claim 27 wherein a magnitude of the portion of the rewards fund is based upon an amount of the monitored purchases and the prior established milestone.

30. The method of claim 19 wherein the predetermined stage of life of the participant comprises a period of staying married or staying alive.

31. The method of claim 19 wherein the predetermined stage of life of the participant comprises an age of a participant.

32. The method of claim 19 wherein the predefined stage of life of the participant is based upon a probability of an occurrence of an event.

33. The method of claim 19 wherein the probability of the occurrence of the event is based upon the probability that a marriage will exist.

34. The method of claim 19 wherein the participant is selected from a segment of a population.

35. The method of claim 19, further comprising initially screening participants and accepting only engaged, newly-wed, or single persons as participants in the rewards program.

36. The method of claim 19 wherein the distributing to the participant the at least the portion of the rewards fund further comprises deferring at least a portion of the rewards fund eligible for distribution until a later stage of life.

37. A method for providing a rewards program to newly-wed participants, comprising:
registering a newly-wed participant in the rewards program;
obtaining from the participant an indication of a commitment to purchase a designated amount of goods and services from at least one vendor or an indication of a commitment to receive a determined amount of reward based upon the participant reaching a marriage milestone; and
at a predetermined stage of life of the participant based upon the participant reaching a marriage milestone, and based upon the participant meeting the indicated commitment, distributing to the participant at least a portion of a rewards fund.

38. The method of claim 37, further comprising:
monitoring participant purchases; and
distributing to the participant the at least the portion of the rewards fund based in part on the monitored participant purchases.

39. The method of claim 37 wherein the marriage milestone is at least one of a 10-year anniversary, a 20-year anniversary, or a 30-year anniversary.

40. The method of claim 37 wherein the indication of the commitment to receive the determined amount of reward indicates one of a $250,000 level, a $500,000 level, or a $1,000,000 level.

41. The method of claim 37 wherein the rewards fund is based at least in part upon commissions provided by one or more vendors participating in the rewards program.

42. The method of claim 37 wherein the registering and obtaining the commitment occur proximate in time.

43. The method of claim 37 wherein the indication of the commitment to receive the determined amount of reward indicates the commitment to purchase the designated amount of goods and services from at least one vendor.

44. The method of claim 37 wherein the distributing to the participant the at least the portion of the rewards fund further comprises deferring at least a portion of the rewards fund eligible for distribution until a later stage of life.

45. A computing system configured to deliver an experiential rewards program comprising:
a memory; and
an administrator module, stored in the memory, that is configured, when executed, to
manage accounts associated with one or more vendors;
obtain an indication of a commitment of a participant to purchase a designated amount of goods or services from at least one vendor of the one or more vendors over a designated time period;
receive a commission from the at least one vendor when the participant purchases goods or services from the at least one vendor and funding a rewards fund based at least in part upon the received commission; and
based upon the participant reaching a predetermined milestone of life of the participant, distribute a portion of the rewards fund to the participant.

46. The system of claim 45 wherein the participant is at least one of a newly-wed or engaged person and the predetermined milestone of life of the participant is an anniversary of a marriage.

47. A computing system configured to deliver a rewards program to a plurality of consumers, comprising:
a memory; and
an administrator module, stored in the memory, that is configured, when executed, to
manage accounts associated with one or more vendors;
obtain an indication of a commitment of a participant to purchase a designated amount of goods or services from at least one vendor of the one or more vendors over a designated time period; and
based upon the participant reaching a predetermined milestone of life of the participant, cause a portion of a rewards fund to be distributed the participant.

48. The system of claim 47, the administrator module further configured, when executed, to:
receive a commission from the at least one vendor when the participant purchases goods or services from the at least one vendor and fund the rewards fund based at least in part upon the received commission;

49. The system of claim 48 wherein the administrator module is further configured to receive the commission from the at least one vendor through an agent.

50. The system of claim 47, wherein the participant is married, and wherein the predetermined milestone of life of the participant is a milestone of the marriage of the participant.

51. The system of claim 50 wherein the milestone of the marriage is at least one of a ten year anniversary, twenty year anniversary, or thirty year anniversary of the marriage.

52. The system of claim 50 wherein a magnitude of the portion of the rewards fund distributed to the participant is in part based upon longevity of the marriage.

53. The system of claim 47 wherein the predetermined milestone of life of the participant comprises the participant reaching a designated age.

54. The system of claim 47 wherein the administrator module is furthered configured to distribute the portion of the rewards fund to the participant when the participant has participated in the rewards program for a predetermined length of time.

55. The system of claim 47, the rewards fund having at least a portion that is distributable based upon a probability of an occurrence of an event.

56. The system of claim 55 wherein the probability defines the likelihood a marriage anniversary of the participant will be reached with the participant still married and alive.

57. The system of claim 47 wherein the administrator module is further configured to distribute the portion of the rewards fund based upon an amount of purchases from the at least one vendor made by the participant.

58. The system of claim 47 wherein the administrator module is further configured to not distribute the portion of the rewards fund when the participant has not met the indicated commitment.

59. The system of claim 47 wherein the rewards fund is an investment fund.

60. The system of claim 47 wherein the indication of the commitment of the participant to purchase the designated amount of goods or services is expressed as a minimum monetary amount.

61. The system of claim 47 wherein the participant is at least one of a newly married person, a person engaged to be married, or a single person.

62. The system of claim 61 wherein the newly married person is a person married less than 3 years.

63. The system of claim 47 wherein the administrator module is further configured to obtain an indication of a commitment of a participant to a designated reward level.

64. A computer-implemented method for managing rewards in a consumer loyalty program, comprising:
managing accounts associated with one or more vendors;
obtaining an indication of a financial spending commitment from a participant to purchase goods or services from at least one vendor of the one or more vendors over a designated time period;
causing funding of a rewards fund; and
at a predetermined stage of the life of the participant, causing a portion of the rewards fund to be distributed to the participant.

65. The method of claim 64, further comprising:
receiving a commission from the at least one vendor when the participant purchases goods or services from the at least one vendor; and
causing the rewards fund to be funded based at least in part upon the received commission.

66. The method of claim 64 wherein the predetermined stage of the life of the participant is comprises a period of staying married or staying alive.

67. The method of claim 64 wherein the predetermined stage of life of the participant comprises at least one of a ten year, twenty year, or thirty year anniversary of the marriage.

68. The method of claim 64 wherein a magnitude of the portion of the rewards fund caused to be distributed to the participant is in part based upon longevity of the marriage.

69. The method of claim 64, the rewards fund having at least a portion that is distributable based upon a probability of occurrence of an event.

70. The method of claim 69 wherein the occurrence of the event is a marriage anniversary of the participant.

71. The method of claim 64, further comprising:
monitoring purchases of the participant; and
causing the portion of the rewards fund to be distributed to the participant at least in part based upon the monitored purchases of the participant.

72. The method of claim 64 wherein the portion of the rewards fund caused to be distributed is based upon an amount of purchases from the at least one vendor.

73. The method of claim 64 wherein the causing the portion of the rewards fund to be distributed is not performed when the participant has not met the indicated financial spending commitment.

73. The method of claim 64 wherein the obtaining the indication of the financial spending commitment comprises obtaining a pledge to spend a minimum amount of money expressed in monetary units.

74. The method of claim 64 wherein the participant is at least one of a newly married person, a person engaged to be married, or a single person.

75. A computer-readable medium containing content that controls a computing system to manage rewards in a loyalty program by performing a method, comprising:
managing accounts associated with one or more vendors;
obtaining an indication of a financial spending commitment from a participant to purchase goods or services from at least one vendor of the one or more vendors over a designated time period;
causing funding of a rewards fund; and
at a predetermined stage of the life of the participant, causing a portion of the rewards fund to be distributed to the participant.

76. The computer-readable medium of claim 75 wherein the computer-readable medium is at least one of a memory of the computing device or a data transmission medium transmitting a generated data signal containing the contents.

77. The computer-readable medium of claim 75 wherein the contents are instructions that, when executed, cause the computing device to perform the method.
